(19) United States
(12) Patent Application Publication
(10) Pub. No.: US 2011/0316988 A1
(43) Pub. Date: Dec. 29, 2011

(54) THREE DIMENSIONAL TELEVISION AND SYSTEM USING RF WIRELESS COMMUNICATION AND METHOD FOR SYNCHRONIZING OF THREE DIMENSIONAL TELEVISION SYSTEM USING THE SAME

(75) Inventors: Bo Yle SEO, Gyeonggi-do (KR); Ji Hoon KIM, Gyeonggi-do (KR); Kwang Mook LEE, Gyeonggi-do (KR); Tah Joon PARK, Gyeonggi-do (KR); Koon Shik CHO, Seoul (KR)

(73) Assignee: SAMSUNG ELECTRO-MECHANICS CO., LTD., Gyunggi-do (KR)

(21) Appl. No.: 13/169,291

(22) Filed: Jun. 27, 2011

(30) Foreign Application Priority Data
Jun. 28, 2010 (KR) 10-2010-0061129

(51) Int. Cl. H04N 13/04

(52) U.S. Cl. 348/51; 348/E13.059

(57) ABSTRACT

Disclosed herein are a 3D TV and a system using RF wireless communication and a method for synchronizing a 3D TV system using the same. In the 3D TV system using the RF wireless communication according to an exemplary embodiment of the present invention, two or more 3D TVs transmit and receive synchronous signals through the RF wireless communication, thereby locking the screen synchronization and synchronous signals of the 3D TVs. Thereafter, when the 3D TVs transmits the synchronous signals to the 3D spectacles, the synchronous signals including the time offset are transmitted, having different time difference. As a result, the 3D spectacles can be synchronized with images displayed on the 3D TVs by using time offset information.

### CROSS REFERENCE TO RELATED APPLICATION

This application claims the benefit of Korean Patent Application No. 10-2010-0061129, filed on Jun. 28, 2010, entitled “Three Dimensional Television And System Using Rf Wireless Communication And Method For Synchronizing Of Three Dimensional Television System Using The Same”, which is hereby incorporated by reference in its entirety into this application.

### BACKGROUND OF THE INVENTION

1. Technical Field

The present invention relates to a 3D TV, and more particularly, to a technology capable of locking synchronous signals between a plurality of 3D TVs by using a RF wireless communication and transmitting the locked synchronous signals to a 3D spectacles.

2. Description of the Related Art

Recently developed 3D TV has largely been in the limelight. The 3D TV is implemented by broadcasting left images and right images sensed by the viewer's left and right eyes, respectively, having time difference. In this case, the viewer wears 3D spectacles. The 3D spectacles receive synchronous signals from the 3D TV to cover the viewer's right eye when the left images are broadcast and cover the viewer's left eye when the right images are broadcast, such that they are synchronized with screens broadcast from the 3D TV. Then, the viewer three-dimensionally recognizes images broadcast from the 3D TV.

Generally, the transmission of the synchronous signals from the 3D TV is made through IR (infrared ray) communication. In this case, the transmission of the synchronous signals through the IR communication transmits time information on the left images or the right images in a pulse form. The IR communication may be implemented at low power and low cost.

However, due to the IR communication, peripheral devices such as an IR remote controller, a fluorescent lamp, or the like, may be easily interfered with each other and with environment and has different receiving states according to the received angle. For example, when the viewer wearing the 3D spectacles turns his/her face at a predetermined angle or more, the 3D spectacles does not receive the synchronous signals transmitted from the 3D TV.

In particular, when there are several 3D TVs, each 3D TV periodically generates different synchronous signals. In this case, since the synchronous signal transmitted by the IR communication includes only the time information on the left images or the right images, it cannot determine whether the 3D spectacles are locked with which one of the two or more received synchronous signals.

Therefore, only one 3D spectacles can only watch one 3D TV because compartments have been installed between each 3D TV at places where several 3D TVs are displayed, such as an exhibit hall, a home appliances selling agency, or the like.

### SUMMARY OF THE INVENTION

An object of the present invention is to provide a 3D TV system capable of synchronizing the screens and the signals of a plurality of 3D TVs by performing RF wireless communication between a plurality of 3D TVs to transmit and receive synchronous signals.

Another object of the present invention is to provide a 3D TV system capable of simultaneously watching a plurality of 3D TVs with one 3D spectacles by allowing a plurality of 3D TVs to transmit synchronous signals including time offset information to 3D spectacles, with different time difference.

Technical problems according to the exemplary embodiments of the present invention may be understood by the following description and be carried out by units shown in the claims and the combination thereof.

According to an exemplary embodiment of the present invention, there is provided a 3D TV system using RF wireless communication, including: two or more 3D TVs of which synchronous signals are locked to each other by performing RF wireless communication therebetween.

The two or more 3D TVs transmit the synchronous signals to the outside, respectively, through the RF wireless communication.

The two or more 3D TVs transmit the synchronous signals to the outside, having different time difference.

The 3D TV system further includes one or more 3D spectacles that is synchronized with images displayed on the 3D TV by using the time offset value included in the synchronous signals after receiving the synchronous signals.

According to another exemplary embodiment of the present invention, there is provided a method for synchronizing a 3D TV system using RF wireless communication, including: (A) confirming whether synchronous signal of other 3D TVs are received through a RF communication unit by a controller; (B) when the synchronous signals of other 3D TVs are received, confirming whether the synchronous signals of other 3D TVs are locked to the synchronous signals of the corresponding 3D TV by the controller; and (C) when the synchronous signals of other 3D TVs do not lock to the synchronous signals of the corresponding 3D TV, performing an adjustment to synchronize a screen of the corresponding 3D TV with the synchronous signals of other 3D TVs by a synchronizing adjustment unit.

The method for synchronizing a 3D TV system using RF wireless communication, further includes: after step (C), (D) generating the synchronous signals locking to the synchronous signals of other 3D TVs by a synchronous signal generator; and (E) transmitting the synchronous signal generated by the RF communication unit to the outside.

At step (E), the RF communication unit transmits the synchronous signals to the outside, having a predetermined time difference from the synchronous signals of other 3D TVs.

The method for synchronizing a 3D TV system using RF wireless communication, further includes: after step (E), (F) receiving the synchronous signals by 3D spectacles; and (G) allowing the 3D spectacles to be synchronized with the images displayed on the 3D TV transmitting the synchronous signals by using the time offset value included in the synchronous signals.

According to another exemplary embodiment of the present invention, there is provided a 3D TV using RF wireless communication, including: an RF communication unit receiving synchronous signals of 3D TVs therearound through RF wireless communication; a synchronous adjustment unit performing an adjustment to synchronize a screen of the 3D TV to synchronous signals of other 3D TVs; a synchronous signal generator generating synchronous signals locking to the synchronous signals of other 3D TVs; and a controller controlling the RF communication unit to transmit the generated synchronous signals to the 3D spectacles.

The controller controls the RF communication unit to transmit the synchronous signals, having the predetermined time difference from the synchronous signals of the other 3D TVs.

The synchronous signal generator generates the synchronous signals including the time offset value for the time difference.

### BRIEF DESCRIPTION OF THE DRAWINGS

FIG. 1 is a diagram schematically showing a 3D TV synchronization system using RF wireless communication according to an exemplary embodiment of the present invention;

FIG. 2 is a diagram showing a state in which a plurality of 3D TVs according to an exemplary embodiment of the present invention set time offset to transmit synchronous signals;

FIG. 3 is a block diagram showing a configuration of a 3D TV using RF wireless communication according to an exemplary embodiment of the present invention; and

FIG. 4 is a flowchart showing a method for synchronizing a 3D TV system using RF wireless communication according to an exemplary embodiment of the present invention.

### DESCRIPTION OF THE PREFERRED EMBODIMENTS

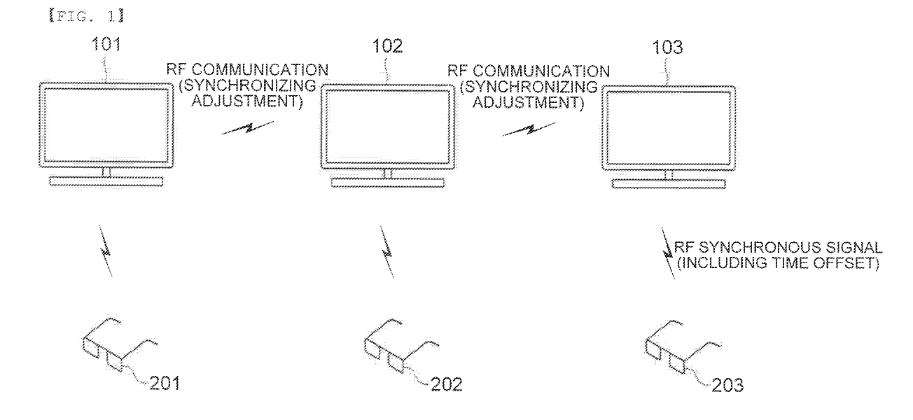

Hereinafter, exemplary embodiments of a 3D TV and a system using RF wireless communication of the present invention and a method for synchronizing a 3D TV system using the same will be described in more detail with reference to FIGS. 1 to 4. However, the invention may be embedded in many different forms and should not be construed as limited to the embodiments set forth herein.

In the following description, when it is determined that the detailed description of the conventional technology related to the present invention would confuse the gist of the present invention, such a description may be omitted. Terms used in the specification and claims herein are defined by considering the functions thereof in the present invention so that they may be varied according to a user's and an operator's intends or practices. Therefore, the definitions thereof should be construed based on the contents throughout the specification.

Consequently, the technical idea of the present invention is determined by the claims and the exemplary embodiments herein are provided so that the technical idea of the present invention will be efficiently explained to those skilled in the art to which the present invention pertains.

FIG. 1 is a diagram schematically showing a 3D TV synchronization system using RF wireless communication according to an exemplary embodiment of the present invention.

Referring to FIG. 1, a 3D TV synchronization system includes one or more 3D TVs 101, 102, and 103 and one or more 3D spectacles 201, 202, and 203. For convenience of explanation, three 3D TVs and 3D spectacles are shown herein but the exemplary embodiments of the present invention are not limited thereto.

The 3D TVs 101, 102, and 103 performs RF wireless communication therebetween. For example, the 3D TVs 101, 102, and 103 each transmit their own synchronous signals and receive synchronous signals from different 3D TVs.

The 3D TVs 101, 102, and 103 refers to the received synchronous signals of different 3D TVs to adjust their own synchronous signals. For example, as a result of receiving the synchronous signals from the first 3D TV 101 by the second 3D TV 102, if it is determined that the synchronous signals of the second 3D TV 102 are different from the synchronous signals of the first 3D TV 101, the second 3D TV 102 should lock its own synchronous signals to the synchronous signals of the first 3D TV 101. In this case, the synchronous signals of the 3D TVs 101, 102, and 103 may be locked to each other through the RF wireless communication therebetween.

The 3D TVs 101, 102, and 103 lock the synchronous signals to each other and then, transmit the synchronous signals to the 3D spectacles 201, 202, and 203. In this case, the 3D TVs 101, 102, and 103 transmit the synchronous signals through the RF wireless communication. Herein, when the 3D TVs 101, 102, and 103 simultaneously transmit the synchronous signals, the interference occurs. As a result, the 3D TVs transmit the synchronous signals, having the predetermined time difference (that is, time offset).

In this case, the synchronous signals may include a screen changing period of left and right images, time offset information, and identification information on the corresponding 3D TV. The exemplary embodiment of the present invention transmits the synchronous signals through the RF wireless communication, such that the time offset information and the identification information on the corresponding 3D TV may be further provided.

The 3D spectacles 201, 202, and 203 receive the synchronous signals from the 3D TVs 101, 102, and 103. When receiving the synchronous signals, the 3D spectacles 201, 202, and 203 uses the time offset information included in the synchronous signals to be synchronized with the images displayed on the corresponding 3D TV.

Herein, the 3D TVs 101, 102, and 103 are already locked to each other. Therefore, even though the 3D spectacles 201, 202, and 203 receive the synchronous signals from any one of the 3D TVs 101, 102, and 103, if they are locked to each other by using the received synchronous signals, they are locked to the images displayed from all the 3D TVs 101, 102, and 103. In this case, each viewer wearing the 3D spectacles 201, 202, and 203 can watch all the 3D TVs 101, 102, and 103.

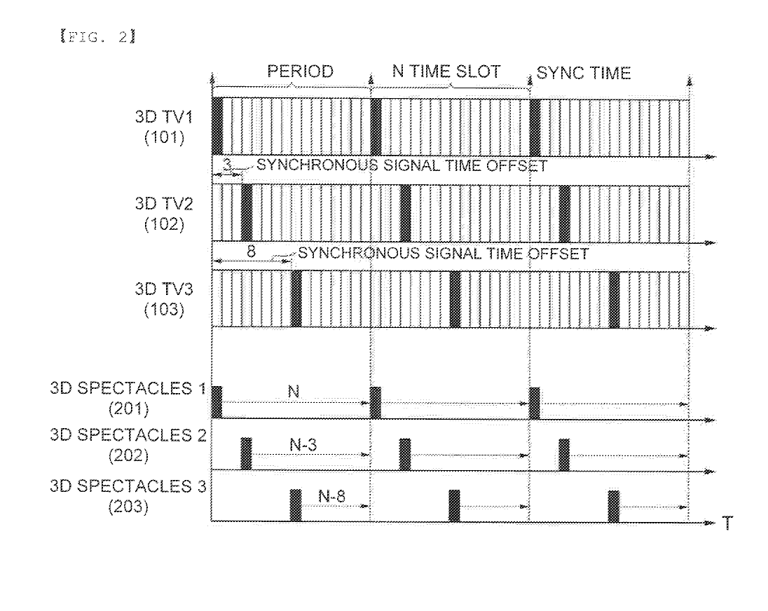

FIG. 2 is a diagram showing a state in which a plurality of 3D TVs according to an exemplary embodiment of the present invention set time offset to transmit synchronous signals. Herein, it is assumed that the first 3D TV 101, the second 3D TV 102, and the third 3D TV 103 are operated by being applied with power in order.

First, the first 3D TV 101 confirms whether the first 3D TV 101 receives the synchronous signals form the corresponding 3D TV from other 3D TVs for the predetermined time. If it is determined that the first 3D TV 101 does not receive the synchronous signals from other 3D TVs for the predetermined time, it is determined that the first 3D TV 101 does not have other 3D TVs locking the synchronous signals therearound and generates the synchronous signals locking its screen period and transmits them to the outside.

The synchronous signals are transmitted with a predetermined period, wherein the period may be divided into N time slots. For example, the first 3D TV 101 may transmit the synchronous signals at the first time slot at each period. The synchronous signal includes the time offset value. In this case, the time offset value becomes 0.

If the second 3D TV 102 is operated by being applied with power, it is confirmed that the synchronous signal of the first 3D TV 101 is received during the process of confirming whether the synchronous signals of other 3D TVs is received. In this case, the second 3D TV 102 locks its own synchronous signals to the received synchronous signals of the first 3D TV 101.

Thereafter, the second 3D TV 102 transmits its own synchronous signals to the outside. In this case, the second 3D TV 102 transmits the synchronous signals, having the predetermined time difference (that is, time offset) with the synchronous signals of the first 3D TV 101, so that the synchronous signals of the first 3D TV 101 do not interfere with the synchronous signals of the first 3D TV 101. For example, the second 3D TV 102 may transmit the synchronous signals at the fourth time slot at each period. The synchronous signal includes the time offset value. In this case, the time offset value becomes 3.

The time offset value 3 means that the second 3D TV 102 transmits the synchronous signal at the fourth time slot in order to avoid the interference with the synchronization signal of the first 3D TV 101 but the actual screen synchronization of the second 3D TV 102 corresponds to the first time slot.

If the third 3D TV 103 is operated by being applied with power, it is confirmed that the synchronous signals of the first 3D TV 101 and the second 3D TV 102 are received during the process of confirming whether the synchronous signals of other 3D TVs is received. In this case, the third 3D TV 103 locks its own synchronous signals to the received synchronous signals of the first 3D TV 101 or the second 3D TV 102.

For example, the third 3D TV 103 locks its own synchronous signals to synchronous signals (that is, synchronous signals transmitted from a 3D TV positioned nearest to the third 3D TV 103) having a large signal magnitude among the received synchronous signals.

It is described herein that the third 3D TV 103 locks its own synchronous signals to synchronous signals having a largest signal magnitude among the received synchronous signals. However, the synchronous signals of the first 3D TV 101 and the second 3D TV 102 are locked to each other, such that the result is the same even though the third 3D TV 103 locks its own synchronous signals to which one of two.

As described above, the first to third 3D TVs 101, 102, and 103 each can lock the synchronous signals to each other through the RF wireless communication. That is, as described above, the second 3D TV 102 and the third 3D TV 103 lock their own synchronous signals to the synchronous signals of the first 3D TV 101.

Thereafter, the third 3D TV 103 transmits its own synchronous signals to the outside. In this case, the third 3D TV 103 transmits the synchronous signals, having the predetermined time difference (i.e., time offset) with the synchronous signals of the first 3D TV 101 and the second 3D TV 102, so that the synchronous signals from the third 3D TV 103 do not interfere with the synchronous signals from the first 3D TV 101 and the second 3D TV 102. For example, the third 3D TV 103 may transmit the synchronous signals at the ninth time slot at each period. The synchronous signal includes the time offset value. In this case, the time offset value becomes 8.

The time offset value 8 means that the third 3D TV 103 transmits the synchronous signal at the ninth time slot in order to avoid the interference with the synchronous signals of the first 3D TV 101 and the second 3D TV 102 but the actual screen synchronization of the third 3D TV 103 corresponds to the first time slot.

Meanwhile, the first 3D spectacles to the third 3D spectacles 201, 203, and 203 may receive the synchronous signals from the first to third 3D TVs 101, 102, and 103. The first 3D spectacles to the third 3D spectacles 201, 203, and 203 receive the synchronous signals from at least one of the first to third 3D TVs 101, 102, and 103, depending on a distance. For convenience of explanation, it is shown herein that the first 3D spectacles 201 receive the synchronous signals from the first 3D TV 101, the second spectacles 202 receive the synchronous signals from the second 3D TV 102, and the third 3D spectacles 203 receive the synchronous signals from the third 3D TV 103.

The first 3D spectacles 201 uses the synchronous signals received from the first 3D TV 101 to be synchronized with images displayed on the first 3D TV 101. In this case, the first 3D spectacles 201 use the time offset value included in the synchronous signal to synchronize the screen. The time offset values included in the synchronous signals of the first 3D TV 101 is 0, such that the first 3D spectacles 210 synchronizes the screens according to the synchronous signals of the first 3D TV 101. For example, when the period of the synchronous signals of the first 3D TV 101 is made at N time slots, the first 3D spectacles 201 periodically perform the synchronization at the time point when N time slots elapse from an instant of receiving the synchronous signals of the first 3D TV 101.

The second 3D spectacles 202 uses the synchronous signals received from the first 3D TV 102 to be locked to images displayed on the second 3D TV 102. In this case, the second 3D spectacles 202 refer to the time offset value included in the synchronous signal to synchronize the screen with the second 3D TV 102. The time offset values included in the synchronous signals of the second 3D TV 102 is 3, such that the second 3D spectacles 210 periodically perform the synchronization at the time point when N−3 time slots elapse from an instant of receiving the synchronous signals of the second 3D TV 102.

The third 3D spectacles 203 uses the synchronous signals received from the third 3D TV 103 to be locked to images displayed on the third 3D TV 103. In this case, the third 3D spectacles 203 refer to the time offset value included in the synchronous signal to synchronize the screen with the third 3D TV 103. The time offset values included in the synchronous signals of the third 3D TV 103 is 8, such that the third 3D spectacles 203 periodically perform the synchronization at the time point when N−8 time slots elapse from an instant of receiving the synchronous signals of the third 3D TV 103.

As described above, after the synchronous signals are locked to each other between the first to third 3D TVs 101, 102, and 103, they are transmitted, having the time offset. The first 3D spectacles to third 3D spectacles 201, 202, and 203 synchronizes the screens using the time offset values included the synchronous signals, such that the viewer can simultaneously watch three 3D TVs 101, 102, and 103 through each spectacles 201, 202, and 203. In this case, each of the 3D spectacles 201, 202, and 203 synchronizes the screens with the first 3D TV 101.

Meanwhile, the RF wireless communication is performed between the 3D spectacles 201, 202, and 203 and the 3D TVs 101, 102, and 103, such that the 3D spectacles 201, 202, and 203 may periodically check their own battery residual amount to transmit the information on the residual amount of battery to the 3D TVs 101, 102, and 103, together with its own identification information. In this case, the 3D TVs 101, 102, and 103 displays the information on the residual amount of battery of the corresponding 3D spectacles on the screen, such that the viewer can confirm it. In addition, the 3D spectacles 201, 202, and 203 may transmit additional information such as their own operational time (or used time), operational state, or the like, to the 3D TVs 101, 102, and 103, together with their own identification information, and display them.

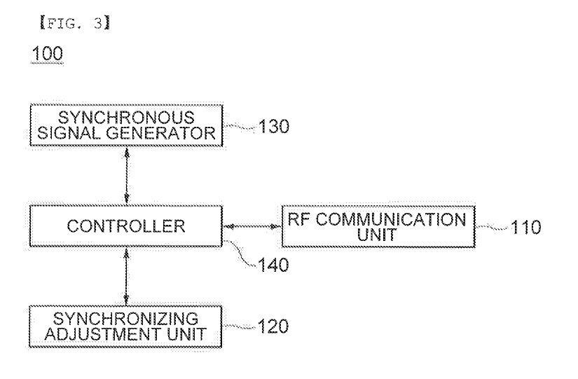

FIG. 3 is a block diagram showing a configuration of a 3D TV using RF wireless communication according to an exemplary embodiment of the present invention.

Referring to FIG. 3, the 3D TV 1.00 includes an RF communication unit 110, a synchronizing adjustment unit 120, a synchronizing signal generator 130, and a controller 140.

The RF communication unit 110 receives the synchronous signals of the corresponding 3D TV from other 3D TVs around the 3D TV 100. In addition, the RF communication unit 110 transmits the synchronous signals generated by the synchronous signal generator 130 to the 3D spectacles.

The synchronizing adjustment unit 120 confirms the synchronous signals of other 3D TVs received by the RF communication unit 110 to synchronize the screen of the 3D TV 100 with the synchronous signals of other 3D TVs.

The synchronizing signal generator 130 generates the synchronous signals locking to the received synchronous signals of other 3D TVs. In this case, the synchronizing signal generator 130 may include the screen changing period of the left and right images, the time offset information, the identification information on the 3D TV 100, or the like, in the synchronous signals.

The controller 140 controls each component. For example, the controller 140 controls the RF communication unit. 110 to receive the synchronous signals of the corresponding 3D TV from other 3D TVs. Next, the controller 140 controls the synchronizing adjustment unit 120 to synchronize the screen of the 3D TV 100 with the received synchronous signals of the 3D TV. Next, the controller 140 controls the synchronizing signal generator 130 to generate the synchronous signal locking to the synchronous signals of the received 3D TV. Next, the controller 140 controls the RF communication unit 110 to transmit the generated synchronous signals to the 3D spectacles.

Meanwhile, the 3D TV 100 may further include a display unit that displays the information on the residual amount of battery, the operational time, and the operational state, etc., transmitted by the 3D spectacles.

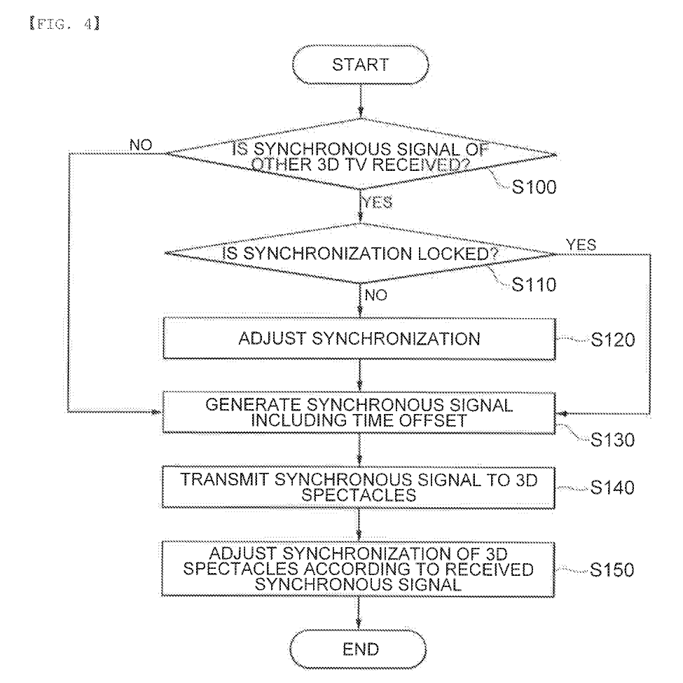

FIG. 4 is a flowchart showing a method for synchronizing a 3D TV system using RF wireless communication according to an exemplary embodiment of the present invention.

Referring to FIG. 4, the controller 140 confirms whether the synchronous signals of the corresponding 3D TV from other 3D TVs therearound are received through the RF communication unit 110 (S100).

As a confirmation result at step S100, when the synchronous signals of other 3D TVs are received, the controller 140 confirms whether the synchronous signals of other 3D TV are locked to the synchronous signals of the corresponding 3D TV (S110).

As the confirmation result at step S110, when the synchronous signals of other 3D TVs do not lock to the synchronous signals of the corresponding 3D TV, the synchronizing adjustment unit 120 performs the adjustment to synchronize the screen of the corresponding 3D TV with the synchronous signals of other 3D TVs (S120).

Next, the synchronizing signal generator 130 generates the synchronous signals locking to the synchronous signals of other 3D TVs (S130). In this case, the synchronizing signal generator 130 may include the screen changing period of the left and right images, the time offset information, the identification information of the 3D TV 100, or the like, in the synchronous signals.

Meanwhile, as the confirmation result at step S100, when the synchronous signal of other 3D TVs are not received, the synchronous signal generator 130 generates the synchronous signals according to the screen synchronization of the corresponding 3D TV. In this case, there is no risk of generating the interference with the synchronous signals of other 3D TVs, such that the time offset value included in the synchronous signals may be set to 0.

As the confirmation result at step S110, when the synchronous signal of other 3D TV locks to the synchronous signals of the corresponding 3D TV, the synchronous signal generator 130 generates the synchronous signals according to the screen synchronization of the corresponding 3D TV. In this case, the synchronous signal generator 130 sets the time offset value to values other than 0 not to generate the interference with the synchronous signals of other 3D TVs and includes them in the synchronous signals.

Next, the RF communication unit 110 transmits the synchronous signals generated by the synchronous signal generator 130 to the 3D spectacles (S140).

Next, the 3D spectacles use the received synchronous signals to be synchronized with the images displayed on the corresponding 3D TV (S150). In this case, the 3D spectacles are synchronized with the screen by referring to the time offset value included in the synchronous signals.

According to the exemplary embodiment of the present invention, it transmits and receives the synchronous signals by using the RF wireless communication between the plurality of 3D TVs, thereby making it possible to synchronize the screens and the signals of the plurality of 3D TVs. The present invention can simultaneously watch the plurality of 3D TVs through one or more 3D spectacles by allowing the plurality of 3D TVs to transmit the synchronous signals including the time offset information to the 3D spectacles, with different time difference.

Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments, hut, on the contrary, is intended to cover various modifications and equivalent arrangements included within the spirit and scope of the appended claims.

What is claimed is:

1. A 3D TV system using RF wireless communication, comprising:
two or more 3D TVs of which synchronous signals are locked to each other by performing RF wireless communication therebetween.

2. The 3D TV system using RF wireless communication according to claim 1, wherein the two or more 3D TVs transmit the synchronous signals to the outside, respectively, through the RF wireless communication.

3. The 3D TV system using RF wireless communication according to claim 2, wherein the two or more 3D TVs transmit the synchronous signals to the outside, having different time difference.

4. The 3D TV system using RF wireless communication according to claim 3, wherein the two or more 3D TVs transmit the synchronous signals including a time offset value for the time difference to the outside.

5. The 3D TV system using RF wireless communication according to claim 4, further comprising one or more 3D spectacles that is synchronized with images displayed on the 3D TV by using the time offset value included in the synchronous signals, after receiving the synchronous signals.

6. The 3D TV system using RF wireless communication according to claim 5, wherein the 3D spectacles transmit at least one of information on the residual amount of battery, operational time, operational state to the 3D TV.

7. A method for synchronizing a 3D TV system using RF wireless communication, comprising:
(A) confirming whether synchronous signal of other 3D TVs are received through a RF communication unit by a controller;
(B) when the synchronous signals of other 3D TVs are received, confirming whether the synchronous signals of other 3D TVs are locked to the synchronous signals of the corresponding 3D TV by the controller; and
(C) when the synchronous signals of other 3D TVs do not lock to the synchronous signals of the corresponding 3D TV, performing an adjustment to synchronize a screen of the corresponding 3D TV with the synchronous signals of other 3D TVs by a synchronizing adjustment unit.

8. The method for synchronizing a 3D TV system using RF wireless communication according to claim 7, further comprising: after step (C),
(D) generating the synchronous signals locking to the synchronous signals of other 3D TVs by a synchronous signal generator; and
(E) transmitting the synchronous signal generated by the RF communication unit to the outside.

9. The method for synchronizing a 3D TV system using RF wireless communication according to claim 8, wherein at step (E), the RF communication unit transmits the synchronous signals to the outside, having a predetermined time difference from the synchronous signals of other 3D TVs.

10. The method for synchronizing a 3D TV system using RF wireless communication according to claim 9, wherein at step (D), the synchronous signal generator generates the synchronous signals including the time offset value for the time difference.

11. The method for synchronizing a 3D TV system using RF wireless communication according to claim 10, further comprising: after step (E),
(F) receiving the synchronous signals by 3D spectacles; and
(G) allowing the 3D spectacles to be synchronized with the images displayed on the 3D TV transmitting the synchronous signals by using the time offset value included in the synchronous signals.

12. A 3D TV displaying 3D images and transmitting synchronous signals for the 3D images to 3D spectacles, the 3D TV using RF wireless communication comprising:
an RF communication unit receiving synchronous signals of 3D TVs therearound through RF wireless communication;
a synchronous adjustment unit performing an adjustment to synchronize a screen of the 3D TV to synchronous signals of other 3D TVs;
a synchronous signal generator generating synchronous signals locking with the synchronous signals of other 3D TVs; and
a controller controlling the RF communication unit to transmit the generated synchronous signals to the 3D spectacles.

13. The 3D TV using RF wireless communication of claim 12, wherein the controller controls the RF communication unit to transmit the synchronous signals, having the predetermined time difference from the synchronous signals of the other 3D TVs.

14. The 3D TV using RF wireless communication of claim 13, wherein the synchronous signal generator generates the synchronous signals including the time offset value for the time difference.

15. The 3D TV using RF wireless communication of claim 12, wherein the 3D TV further includes a display unit displaying at least one of information on the residual amount of battery, operational time, operational state transmitted by the 3D spectacles.
